(19) United States
(12) Patent Application Publication
(10) Pub. No.: US 2015/0040955 A1
(43) Pub. Date: Feb. 12, 2015

(54) Autographable Crutch

(71) Applicant: Medline Industries, Inc., Mundelein, IL (US)

(72) Inventors: Linda Walther, Bristol, WI (US); Ethan Abernathey, Chicago, IL (US); Michael Turturro, Chicago, IL (US)

(73) Assignee: Medline Industries, Inc., Mundelein, IL (US)

(21) Appl. No.: 13/961,631

(22) Filed: Aug. 7, 2013

(51) Int. Cl. A61H 3/02

(52) U.S. Cl. CPC A61H 3/02
USPC 135/66; 427/2.1

(57) ABSTRACT

An autographable crutch (300) includes a crutch (322) and a marking receiving coating 302. The marking receiving coating at least partially covers the crutch and accepts a marking (330) from a marking instrument (331).

### BACKGROUND

1. Technical Field

This disclosure relates generally to medical devices, and more particularly to crutches.

2. Background Art

Crutches have been used for centuries during rehabilitation of injuries to hips and legs. For example, when a leg is broken or an ankle is sprained, a person may use one or two crutches while the leg or ankle heals.

While crutches have been used for a long time, and while some of the materials used to make crutches have become stronger and lighter, the essential design, shape, and function of a crutch has not changed. A person uses a crutch to reduce the amount of weight loading an injured body portion. A person also uses a crutch to increase stability and balance when a lower limb or connecting part is injured or otherwise not available for mobility.

As the design of crutches has not varied for a long time, it would be advantageous to have an improved crutch design.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates a crutch in accordance with one or more embodiments of the disclosure.

FIG. 2 illustrates an explanatory autographable crutch in accordance with one or more embodiments of the disclosure.

FIG. 3 illustrates an explanatory method of using an autographable crutch in accordance with one or more embodiments of the disclosure.

FIG. 4 illustrates another explanatory autographable crutch in accordance with one or more embodiments of the disclosure.

FIG. 5 illustrates another explanatory autographable crutch in accordance with one or more embodiments of the disclosure.

FIG. 6 illustrates another explanatory autographable crutch in accordance with one or more embodiments of the disclosure.

FIG. 7 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide for an autographable crutch. In one embodiment, a crutch includes a marking receiving coating. As used herein, a “marking receiving coating” is a special coating configured to receive markings from a marking instrument where those markings dry quickly, are at least semi-permanent, and are not readily altered mechanically by, for example, smearing or smudging, unless otherwise designated in limited embodiments.

In one embodiment, the marking receiving coating at least partially covers the crutch. In one embodiment, the marking receiving coating covers the entire crutch. In another embodiment, where the crutch is manufactured from a particular material, such as wood or plastic, the marking receiving coating is disposed only on exposed portions of the material, i.e., exposed metal or exposed wood. In other embodiments, the marking receiving coating is selectively disposed along portions of the crutch to perform two functions: first, the marking receiving coating is to accept a marking from a marking instrument such as a pen, marker, or pencil. Second, the selective application of the marking receiving coating can impart an aesthetically pleasing appearance to the crutch. In yet other embodiments, the marking receiving coating can be selectively disposed on the crutch so as to indicate that the crutch is, in fact, an autographable crutch.

Autographable crutches configured in accordance with one or more embodiments of the disclosure provide numerous advantages over prior art crutches. A principle advantage is the providing the ability for a user of the crutch to receive autographs and get-well wishes from friends, family, and acquaintances. The disclosure contemplates that modern casts are fiberglass instead of plaster, and that fiberglass does not constitute a marking receiving coating as markings from markers and ink pens applied to fiberglass are slow to dry, impermanent, and smudge and smear easily. At the same time, the inventors have determined that friends, family, and acquaintances still desire to provide well wishes to those suffering from injury or other conditions requiring the use of medical devices in the form of markings. Embodiments of the disclosure advantageously provide a device to receive markings and display them so that received autographs and get-well wishes can be displayed during recovery.

In one embodiment, to create the autographable crutch, at least a portion of the crutch is coated with a marking receiving coating. The color of the coating can vary. For example, it can be a clear coating in one embodiment. In another embodiment, it can be a white coating. In another embodiment, it can be a colored coating, such as grey, red, blue, yellow, or green. In one embodiment, the marking receiving coating comprises a colored pigment selected to render markings disposed thereon visible to an onlooker. Once the marking receiving coating is disposed on at least portions of the crutch, markings from a marking instrument can be deposited on the marking receiving coating.

The marking receiving coating can be adapted to a predetermined marking to be received. For example, in one embodiment, the marking instrument is a marker. The marker can be indelible or non-permanent. The marking receiving coating can be adapted so that marker markings dry quickly and do not smudge. Similarly, in another embodiment, the marking instrument is an ink pen. Ink pens may use different inks from markers. Accordingly, the marking receiving coating can be adapted so that ink pen markings dry quickly and do not smudge. In yet another embodiment, the marking instrument can be a pencil. The marking receiving coating can be adapted so that pencil markings are at least semi-permanent and do not smudge readily. In yet another embodiment, the marking instrument can be chalk. The marking receiving coating can be adapted so that chalk markings are retained on the coating and do not erase easily.

In yet other embodiments, the user of the autographable crutch may want to continually reconfigure the crutch. Accordingly, in one embodiment the marking instrument may be a dry erase marker. The marking receiving coating can be adapted so that markings are easily erasable by making the coating glossy.

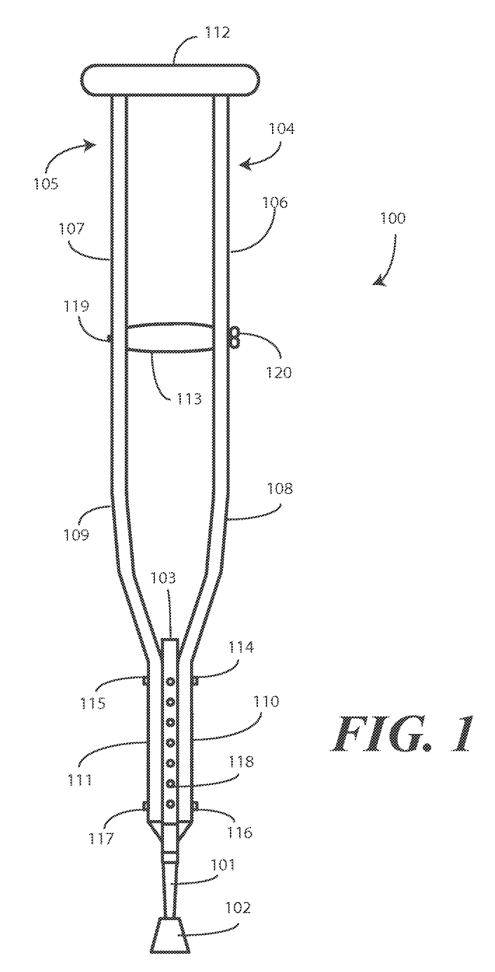

Turning now to FIG. 1, illustrated therein is a crutch 100 in accordance with one or more embodiments of the disclosure. The crutch 100 can be manufactured from metal, wood, fiberglass, carbon fiber, or other materials.

In one embodiment, the crutch 100 includes a substantially vertical, lower leg 101. The lower leg 101 can be covered with a slip-resistant tip 102 configured to increase a friction coefficient between the crutch 100 and a floor, street, or the ground.

An upper leg 103 extends from the lower leg 101. The upper leg 103 is disposed between lower portions of a pair of opposing vertical crutch columns 104,105. Each vertical crutch column 104,105 includes a plurality of sections. The sections include upper crutch sections 106,107, lower crutch sections 108,109, and leg coupling sections 110,111. In this illustrative embodiment, the lower crutch sections 108,109 are upwardly and outwardly inclined or curved as they extend from the leg coupling sections 110,111. The upper crutch sections 106,107 of this particular crutch 100 are substantially parallel, straight, and vertical.

The upper crutch sections 106,107 intersect a body-engaging beam 112 of the crutch 100. When the crutch 100 is in use, the body-engaging beam 112 is traditionally placed between the user's upper arm and torso beneath the armpit. The crutch 100 also includes a handgrip 113 that is disposed between the vertical crutch columns 104,105 between the upper crutch sections 106,107 and the lower crutch sections 108,109.

In FIG. 1, the vertical crutch columns 104,105 are coupled to the upper leg 103 at the leg coupling sections 110,111. The upper leg 103 can be adjustable within the leg coupling sections 110,111. In one embodiment, the upper leg 103 is releasable and movable within the leg coupling sections via bolts 114,116 or spring-loaded mechanical protrusions. In some embodiments the bolts 114,116 can be secured with wing nuts 115,117. Apertures 118 in the upper leg 103 allow the upper leg 103 to move vertically between the leg coupling sections 110,111 when the bolts 114,116 are removed. Locking the bolts 114,116 with the wing nuts 115,117 retains the upper leg 103 securely between the leg coupling sections 110,111.

As shown in FIG. 1, the handgrip 113 can be mounted between the vertical crutch columns 104,105 with a bolt 119 and wing nut 120 as well. As with the upper leg 103, the vertical crutch columns can include a plurality of apertures through which the bolt 119 can be placed to raise and lower the handgrip 113.

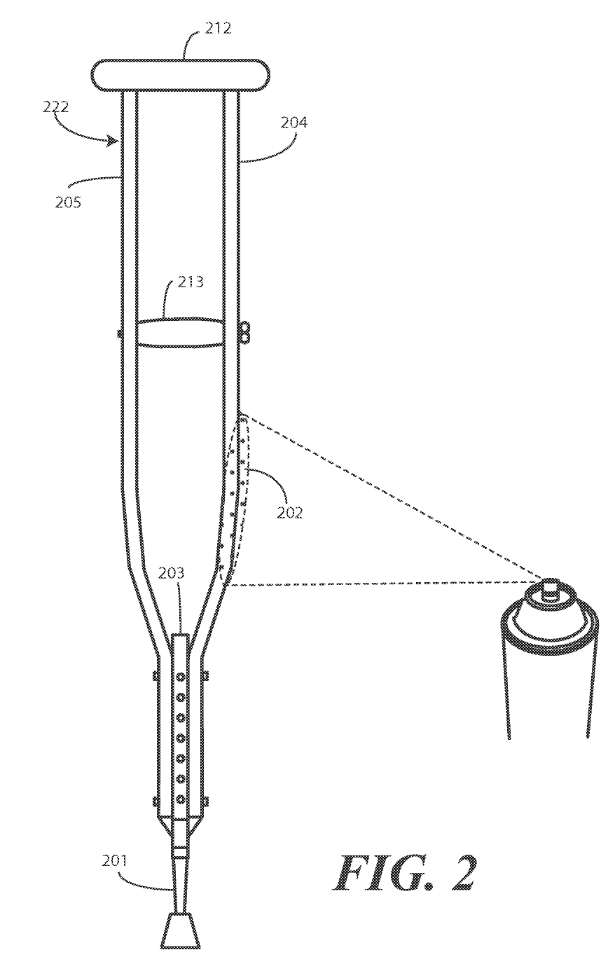

Turning now to FIG. 2, illustrated therein is one example of an autographable crutch 200 configured in accordance with one or more embodiments of the disclosure. The autographable crutch 200 is a device in accordance with the disclosure. For illustration purposes, the autographable crutch 200 is shown as a full crutch. However, it will be clear to those of ordinary skill in the art having the benefit of this disclosure that it could be configured in other ways as well. For example, the autographable crutch 200 can be configured as any of an axillary crutch, a forearm crutch, or a platform crutch.

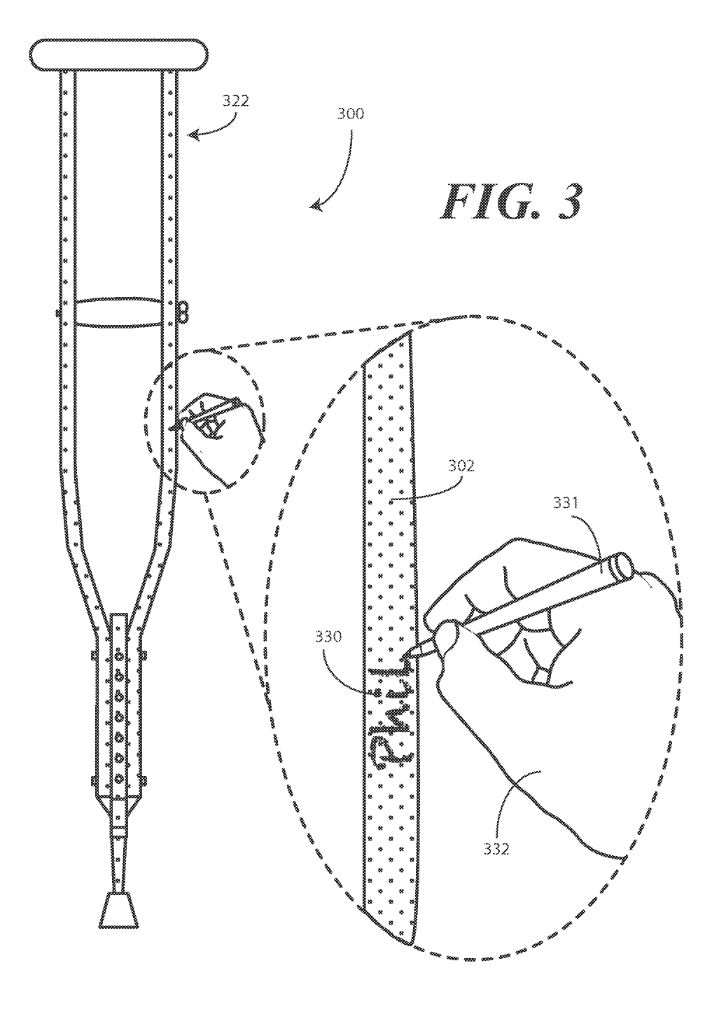

As shown, a marking receiving coating 202 is applied to at least partially cover the crutch 222. In one embodiment, the marking receiving coating 202 is to accept and/or receive a marking from a marking instrument as will be described below with reference to FIG. 3. The marking receiving coating 202 can take a variety of forms, a few embodiments of which will be set forth for illustrative purposes. In one embodiment, the marking receiving coating 202 comprises paint. For example, the paint in one embodiment can be an epoxy-based paint. In one embodiment, the paint comprises an epoxy-based enamel, such as an epoxy acrylic enamel. In other embodiments, the paint comprises an alkyd enamel, acrylic enamel, or other type of paint. Epoxy based paints are coatings that include chemical resins that, when reacted with oxygen form a hard, abrasion resistant, chemical, and solvent resistant coating. It will be clear to those of ordinary skill in the art having the benefit of this disclosure that other coatings can be used as the marking receiving coating 202 as well. For example, urethanes, oil-based coatings, latex coatings, polyester coatings, polyamide coatings, and other coatings can be used in some embodiments.

In one embodiment, the marking receiving coating 202 comprises a matte finish. Other embodiments, such as the dry erase marker scenario described above, may employ a glossy, shiny, or smooth coating. However, in many embodiments, a matte finish is well suited to receiving markings from marking instruments and allowing those markings to dry quickly, be permanently or semi-permanently retained, and resist smearing or smudging.

As noted above, the marking receiving coating 202 can comprise various colors. For example, it can be a clear coating in one embodiment. In another embodiment, it can be a white coating. In another embodiment, it can be a colored coating, such as grey, red, blue, yellow, or green. In one embodiment, the marking receiving coating 202 comprises a colored pigment selected to render markings disposed thereon visible to an onlooker. Once the marking receiving coating 202 is disposed on at least portions of the crutch, markings from a marking instrument can be deposited on the marking receiving coating.

The marking receiving coating 202 applied can be adapted to a predetermined marking to be received. Additionally, the marking receiving coating 202 can be to receive a marking without smearing. For example, in one embodiment, the marking instrument is a marker. The marker can be indelible or non-permanent. The marking receiving coating 202 can be adapted so that marker markings dry quickly and do not smudge. Similarly, in another embodiment, the marking instrument is an ink pen. Ink pens may use different inks from markers. Accordingly, the marking receiving coating 202 can be adapted so that ink pen markings dry quickly and do not smudge. In yet another embodiment, the marking instrument can be a pencil. The marking receiving coating 202 can be adapted so that pencil markings are at least semi-permanent and do not smudge readily. In yet another embodiment, the marking instrument can be chalk. The marking receiving coating 202 can be adapted so that chalk markings are retained on the coating and do not erase easily.

The marking receiving coating 202 can be deposited on various portions, or alternatively the entirety, of the crutch 222. For example, in one embodiment the marking receiving coating 202 is disposed on the vertical crutch columns 204,205 of the crutch 222. In one embodiment, the marking receiving coating 202 is disposed only on portions of the vertical crutch columns 204,205. In another embodiment, the marking receiving coating 202 is disposed on an entirety of the vertical crutch columns 204,205. In another embodiment, the marking receiving coating 202 is disposed on the upper leg 203 of the crutch 222. In another embodiment, the marking receiving coating 202 is disposed on the lower leg 201 of the crutch 222. Of course, combinations of these can be used. For example, in one embodiment the marking receiving coating 202 is disposed on an entirety of the crutch 222. In yet another embodiment, where the crutch 222 is manufactured from a material such as wood, metal, fiberglass, carbon fiber, or other materials, the marking receiving coating 202 can be disposed on exposed portions of the material. Exposed portions would generally exclude portions disposed beneath the handgrip 213 or the body-engaging portion 212.

Turning now to FIG. 3, illustrated therein is another autographable crutch 300 in accordance with one or more embodiments of the disclosure. FIG. 3 also illustrates a method for using the autographable crutch 300.

As shown in FIG. 3, a coating 302 has been applied to at least a portion of a crutch 322 to create the autographable crutch 300. In this embodiment, the coating 302 has been applied to all rigid portions of the crutch 322.

In this embodiment, the coating 302 comprises a coating to receive a marking 330 from a marking instrument 331. Application of the coating 302 to the crutch 322 has transformed the crutch 322 into an autographable crutch 300.

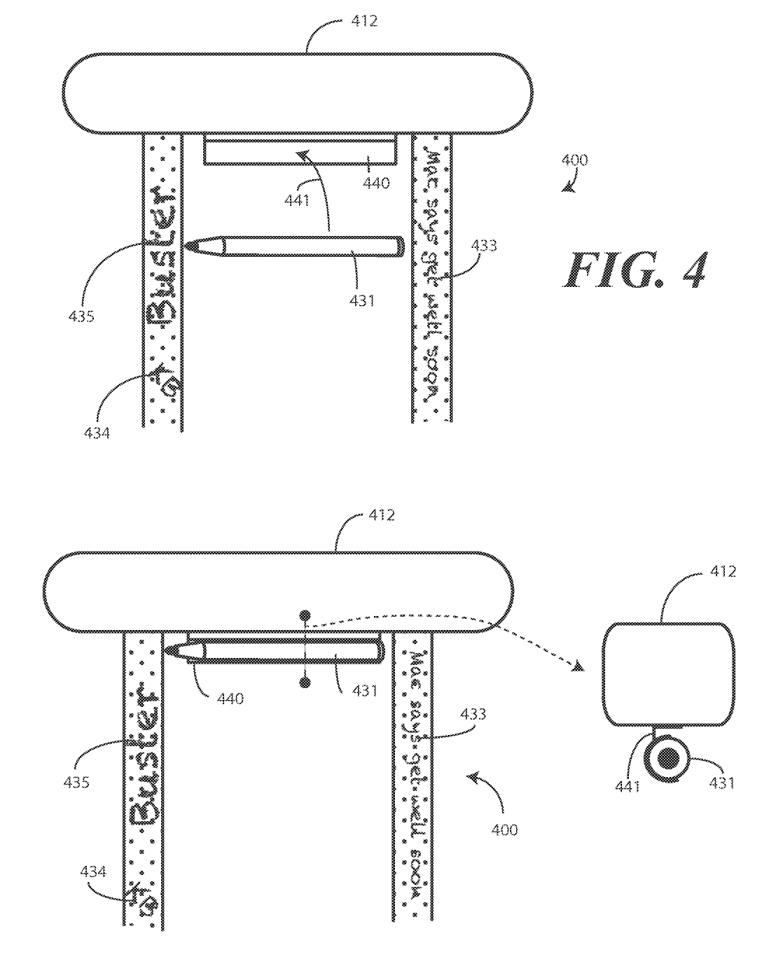

A person 332 is marking the coating 302 with a marking 330. In this illustrative embodiment, the marking 330 is an autograph. Accordingly, the person 332 is marking the coating 302 by autographing the autographable crutch 300. As will be shown in FIG. 4, the marking 330 can take other forms, including get-well messages (433). Where that is the case, the person 332 may mark the coating by applying the get-well message to the coating 302 of the autographable crutch 300 by applying a get-well message (433) to the coating 302. Other types of markings 330 will be obvious to those of ordinary skill in the art having the benefit of this disclosure. For example, the marking 330 could alternatively be an advertisement, a design, a picture, a logo, a representing a favorite hobby or sporting team.

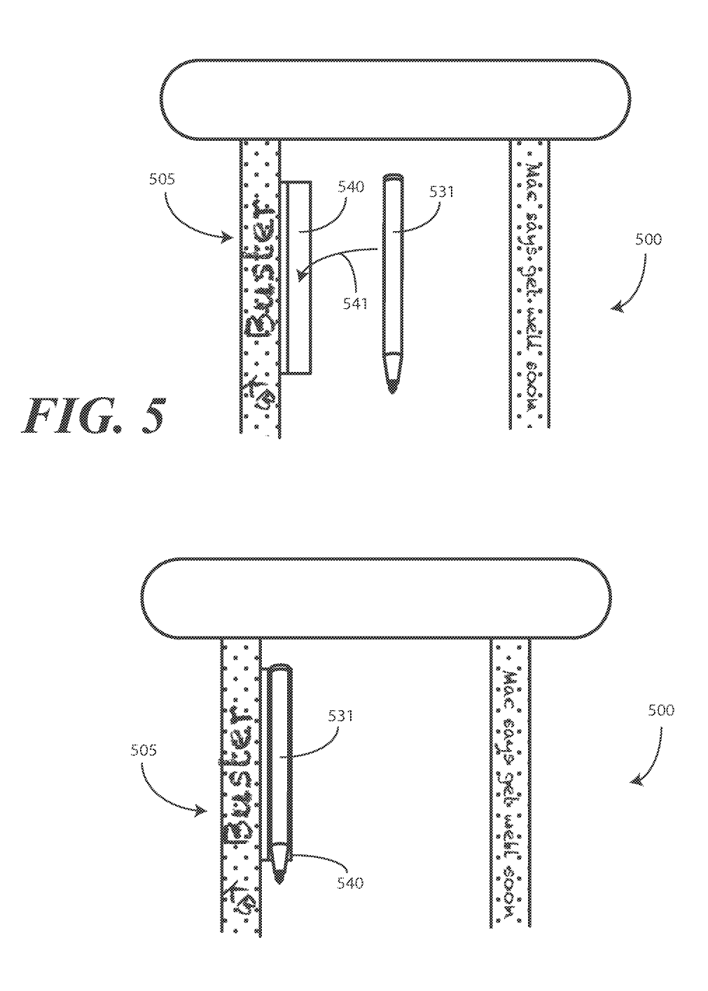

As noted previously, the coating 302 can be adapted to receive markings from a particular marking instrument 331. Manufacturers may desire to pair specific marking instruments with particular coatings. In other applications, the user of the autographable crutch 300 may want to have a pen, pencil, marker, or other marking instrument handy at all times. To accommodate either scenario, in one embodiment an autographable crutch can be configured with a holder for the marking instrument. Examples of such an embodiment are shown in FIGS. 4 and 5.

Beginning with FIG. 4, an autographable crutch 400 comprises a holder 440 to receive 441 a marking instrument 431. In one embodiment, the marking instrument 431 comprises a marker. In another embodiment, the marking instrument 431 comprises a pencil. In another embodiment, the marking instrument 431 comprises an ink pen. In another embodiment, the marking instrument 431 comprises chalk. In another embodiment, the marking instrument 431 comprises a dry erase marker.

In this illustrative embodiment, the holder 440 comprises a C-shaped clip that receives 441 the marking instrument 431. The C-shape expands with the marking instrument 431 is inserted, and then clasps the marking instrument 431 within the C-shape. In one embodiment, the holder 440 is manufactured from a pliable plastic material. In another embodiment, the holder 440 is manufactured from a springy metal material.

In the illustrative embodiment of FIG. 4, the holder 440 is coupled to the body-engaging beam 412 of the autographable crutch 400. In one embodiment, the holder 440 is adhesively attached to the body-engaging beam 412. In another embodiment, the holder 440 is bonded to the body-engaging beam 412 of the autographable crutch 400. In another embodiment, the holder 440 is screwed or bolted to the body-engaging beam 412 of the autographable crutch 400. Other connection or coupling techniques will be obvious to those of ordinary skill in the art having the benefit of this disclosure.

Note that various illustrative markings are shown in FIG. 4. These markings include initials 434, an autograph 435, and a get-well message 433.

Turning to FIG. 5, an autographable crutch 500 comprises another holder 540 to receive 541 a marking instrument 531. In this illustrative embodiment, the holder 540 comprises a magnetic clip that receives 541 the marking instrument 531.

In the illustrative embodiment of FIG. 5, the holder 540 is coupled to the vertical crutch column 505 of the autographable crutch 500. In one embodiment, the holder 540 is adhesively attached to the vertical crutch column 505. In another embodiment, the holder 540 is magnetically coupled to the vertical crutch column 505. In another embodiment, the holder 540 is bonded to the vertical crutch column 505. In another embodiment, the holder 540 is screwed or bolted to the vertical crutch column 505. Other connection or coupling techniques will be obvious to those of ordinary skill in the art having the benefit of this disclosure. Additionally, while the body-engaging beam (412) and the vertical crutch column 505 are two convenient places to attach a holder 540, other portions of the autographable crutch 500 will be obvious to those of ordinary skill in the art having the benefit of this disclosure.

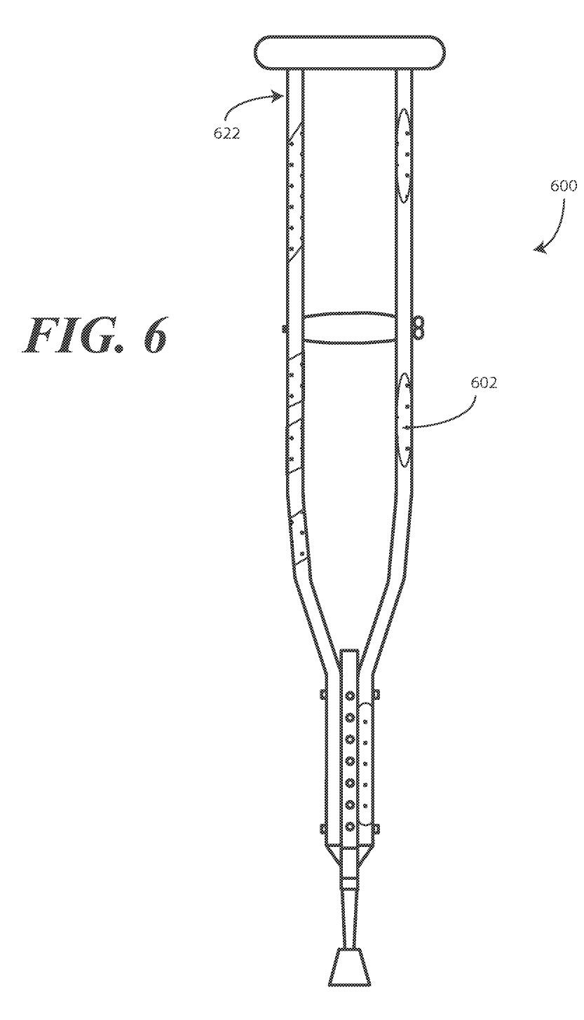

Turning now to FIG. 6, illustrated therein is another autographable crutch 600. In this embodiment, a marking receiving coating 602 has been selectively applied only to portions of the crutch 622. The locations at which the marking receiving coating 602 is disposed can vary based upon application or desire. For example, the selective locations can define a fashion statement, unique design, artistic design, or provide an aesthetically pleasing appearance in one embodiment. In other embodiments, the selective locations can provide a visible indication that the crutch 622 is, in fact, an autographable crutch 600. Accordingly, people seeing the visible indication will be alerted to the fact that they may autograph, mark, or otherwise place a marking on the selective locations of the autographable crutch 600.

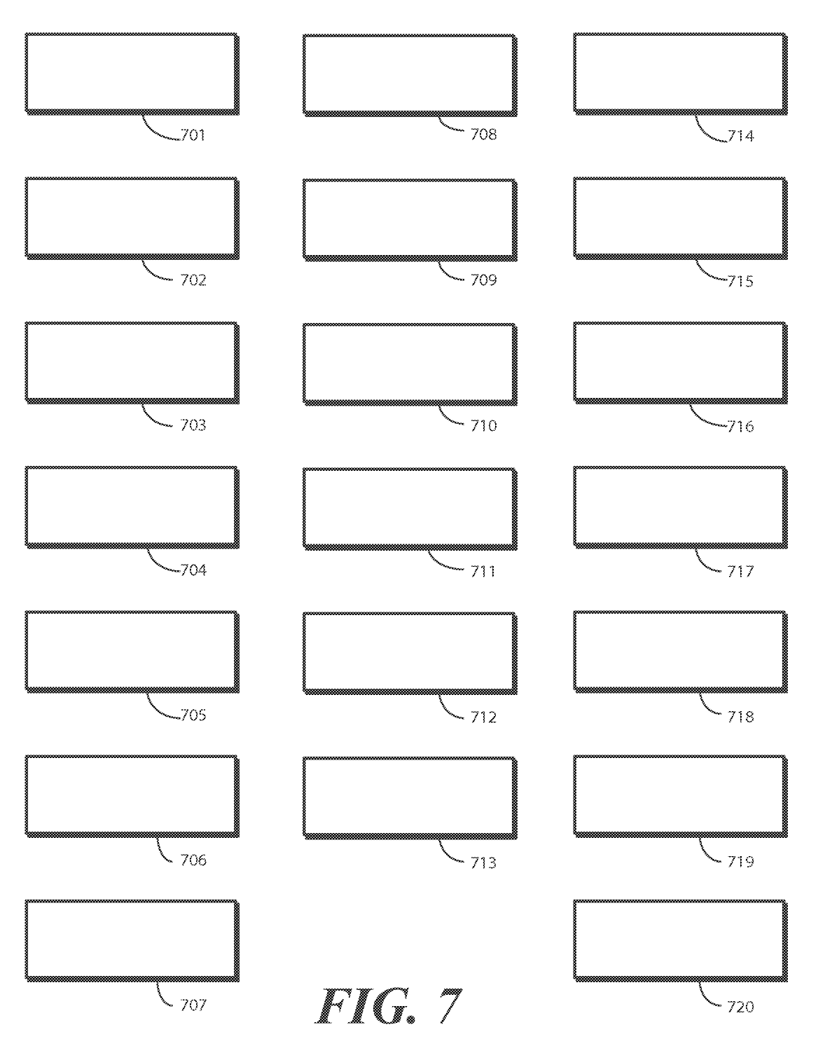

Turning now to FIG. 7, illustrated therein are various embodiments of the disclosure. At 701, a device includes a crutch and a marking receiving coating at least partially covering the crutch, the marking receiving coating to accept a marking from a marking instrument. At 702, the marking receiving coating of 701 comprises paint. At 703, the paint of 702 comprises epoxy. At 704, the paint of 702 comprises a matte finish. At 705, the paint of 702 comprises enamel. At 706, the paint of 702 is white.

At 707, the marking receiving coating of 701 is disposed on one or more vertical crutch columns of the crutch. At 708, the marking receiving coating of 701 is disposed on an entirety of the vertical crutch columns of 707. At 709, the marking receiving coating of 701 is further disposed on an upper leg section of the crutch. At 710, the marking receiving covering of 701 is selectively disposed on the crutch.

At 711, the marking instrument of 701 comprises an ink pen. At 712, the marking instrument of 701 comprises a marker. At 713, the marking receiving coating of 701 receives the marking without smearing or substantially smearing.

At 714, the crutch of 701 further comprises a holder for the marking instrument. At 715, the holder is coupled to a body-engaging beam of the crutch. At 716, the holder is coupled to a vertical crutch column of the crutch.

At 717, a method of using an autographable crutch comprises marking a coating at least partially covering the crutch with a marking instrument. At 718, the marking of 717 comprises autographing the coating of the crutch such that the marking left is an autograph. At 719, the marking comprises applying a get-well message to the coating of the crutch.

At 720 a method of manufacturing an autographable crutch comprises applying a coating to at least a portion of a crutch. At 720, the coating is to receive a marking from a marking instrument. At 720, the applying transforms the crutch to an autographable crutch.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A device, comprising:
a crutch; and
a marking receiving coating at least partially covering the crutch, the marking receiving coating to accept a marking from a marking instrument.

2. The device of claim 1, the marking receiving coating comprising paint.

3. The device of claim 2, the paint comprising epoxy.

4. The device of claim 2, the paint comprising a matte finish.

5. The device of claim 2, the paint comprising enamel.

6. The device of claim 2, the paint white.

7. The device of claim 1, the marking receiving coating disposed on vertical crutch columns of the crutch.

8. The device of claim 7, the marking receiving coating disposed on an entirety of the vertical crutch columns.

9. The device of claim 1, the marking receiving coating further disposed on an upper leg section of the crutch.

10. The device of claim 1, the marking receiving covering selectively disposed on the crutch.

11. The device of claim 1, the marking instrument comprising an ink pen.

12. The device of claim 11, the marking instrument comprising a marker.

13. The device of claim 11, the marking receiving coating to receive the marking without smearing.

14. The device of claim 1, further comprising a holder for the marking instrument.

15. The device of claim 14, the holder coupled to a body-engaging beam of the crutch.

16. The device of claim 14, the holder coupled to a vertical crutch column of the crutch.

17. A method, comprising:
marking a coating at least partially covering a crutch with a marking instrument.

18. The method of claim 17, the marking comprising an autograph.

19. The method of claim 17, the marking comprising applying a get-well message to the coating of the crutch.

20. A method, comprising:
applying a coating to at least a portion of a crutch, the coating to receive a marking from a marking instrument, the applying transforming the crutch to an autographable crutch.
